(19) United States
(12) Patent Application Publication
(10) Pub. No.: US 2012/0214097 A1
(43) Pub. Date: Aug. 23, 2012

(54) MAGNETIC CARRIER AND TWO-COMPONENT DEVELOPER

(75) Inventors: Takeshi Naka, Suntou-gun (JP); Yoshinobu Baba, Yokohama-shi (JP); Koh Ishigami, Mishima-shi (JP)

(73) Assignee: CANON KABUSHIKI KAISHA, Tokyo (JP)

(21) Appl. No.: 13/217,216

(22) Filed: Aug. 24, 2011

(30) Foreign Application Priority Data
Sep. 6, 2010 (JP) 2010-1986399(PAT.

(51) Int. Cl. G03G 9/113

(52) U.S. Cl. 430/111.32; 430/111.35; 430/137.13

(57) ABSTRACT

Provided are a magnetic carrier and a two-component developer comprising the magnetic carrier. The magnetic carrier comprises magnetic carrier particles, each of which comprises a magnetic carrier core, the surface of which is coated with a charge control agent and further coated with a resin coat layer containing a resin composition.

### BACKGROUND OF THE INVENTION

1. Field of the Invention

The present invention relates to a magnetic carrier and a two-component developer used in electrophotography and electrostatic recording.

2. Description of the Related Art

As the magnetic carrier used in a two-component developer, a magnetic carrier formed by coating a resin composition onto the surface of a ferrite core or a resin core having a magnetic substance dispersed therein has been used in order to improve electrification characteristics and durability of a magnetic carrier. Furthermore, in order to stabilize electrification characteristics after long-term use (running) or leaving in an environment, a magnetic carrier containing a charge control agent is used.

In Japanese Patent Application Laid-Open No. H08-160674, a magnetic carrier is described, which contains a charge control agent in a coating resin composition and/or on the surface in order to suppress toner spent to a minimum and obtain a magnetic carrier whose electrification characteristics are not changed by e.g., shock and friction.

In the magnetic carrier, since a charge controlling function is given to the resin composition, electrification characteristics of the carrier is excellent. However, since the coating resin is obtained by solution polymerization, the coating resin contains a large amount of low-molecular weight component having a weight average molecular weight (Mw) of about several tens of thousands. Thus, if a toner containing a large amount of external additive(s) is used, the coating resin of the magnetic carrier is sometimes scraped off.

Furthermore, in the case where a developing unit was left alone for several days under a high-temperature and high-humidity environment after long-term use, a resin coat layer was scraped off due to the effect of the low-molecular weight component and a charge control agent is exposed, with the result that so-called toner spent, a phenomenon where a toner adsorbs onto the surface of a magnetic carrier, sometimes occurs.

In Japanese Patent Application Laid-Open No. 2007-101812, a magnetic carrier is described, which is formed by coating the surface of a magnetic carrier core with a coupling agent and further coated with a resin composition in order to improve adhesion between the magnetic carrier core and the resin composition and stably maintain a high charge amount.

In the above magnetic carrier, adhesion of a resin composition is excellent and stability of a charge amount is excellent, whereas charge imparting ability and long-term durability are not sufficient.

In Japanese Patent Application Laid-Open No. 2009-063805, a magnetic carrier is described, which is formed by dissolving or softening a resin composition and a charge control agent by fixing them onto the surface of a magnetic carrier core while repeatedly giving mechanical shock under heating in order to maintain charge imparting ability and long-term durability.

In the magnetic carrier, since a charge control agent is dispersed in a resin composition by dissolution or softening, the charge amount of the carrier is excellent in stability. However, if the charge amount reduces by long-term use, fogging sometimes occurs when an image is formed. This is conceivably because a charge control agent wears out and leaves while triboelectric charging is repeated in a developing unit during long-term use.

As described above, obtaining a magnetic carrier having a high charge amount and a high developability, capable of suppressing fogging, and excellent in charge maintaining property after leaving in the environment and after long-term use is a problem to be solved.

### SUMMARY OF THE INVENTION

An object of the invention is to provide a magnetic carrier and two-component developer overcoming the above problem. More specifically, an object of the invention is to provide a magnetic carrier having a high charge amount and a high developability, capable of suppressing fogging and maintaining a satisfactory charging ability even after leaving in the environment or formation of a large number of images.

According to an aspect of the present invention, there is provided a magnetic carrier comprising magnetic carrier particles, each of which comprises a magnetic carrier core, a charge control agent and a resin composition, wherein the surface of the magnetic carrier core is coated with the charge control agent, and wherein a resin coat layer containing the resin composition is present on the surface of a coat of the charge control agent.

According to another aspect of the present invention, there is provided a two-component developer using the above magnetic carrier.

The present invention makes it possible to provide a magnetic carrier and two-component developer having a high charge amount and a high developability, capable of suppressing fogging and maintaining a satisfactory charging ability even after leaving in the environment or formation of a large number of images.

Further features of the present invention will become apparent from the following description of exemplary embodiments with reference to the attached drawings.

### BRIEF DESCRIPTION OF THE DRAWINGS

FIG. 1 is a schematic sectional view illustrating a dry-process coating apparatus used in a coating process for a magnetic carrier core.

FIG. 2A is a schematic view illustrating the structure of a stirring member in the dry-process coating apparatus shown in FIG. 1.

FIG. 2B is a schematic view illustrating the structure of a stirring member in the dry-process coating apparatus shown in FIG. 1.

FIG. 3 is a schematic view illustrating the structure of an apparatus for measuring a toner load on a photosensitive member and a charge amount.

FIG. 4 is a schematic sectional view illustrating a conventional coating apparatus used in coating process for a magnetic carrier core.

### DESCRIPTION OF THE EMBODIMENTS

Preferred embodiments of the present invention will now be described in detail in accordance with the accompanying drawings.

<Magnetic Carrier>

The magnetic carrier of the present invention comprises magnetic carrier particles, each of which comprises a magnetic carrier core, a charge control agent and a resin composition, in which the surface of the magnetic carrier core is coated with the charge control agent, on which a resin coat layer containing the resin composition is present. By virtue of the structure, the magnetic carrier of the present invention exhibits excellent properties such as a high charge amount and a high developability and an ability to suppress fogging and an ability to maintain a satisfactory charging ability even after leaving in the environment or formation of a large number of images.

As described above, conventionally, to enhance electrification characteristics of a magnetic carrier, a coating resin and a charge control agent are allowed to present on the surface of a magnetic carrier core. Furthermore, for enhancing developability of the magnetic carrier, it is known to be effective to reduce the resistivity of the magnetic carrier core. Furthermore, as other measures for enhancing the developability, it is known to be effective to provide convexoconcave portions on the surface of the magnetic carrier core.

However, in the magnetic carrier having a low-resistant magnetic carrier core, which is covered with a coating resin having a charge control agent dispersed therein, it is difficult to suppress a reduction of charge imparting ability of the magnetic carrier under a high-temperature and high-humidity environment. Furthermore, when a magnetic carrier core having convexoconcave portions on the surface is coated with a resin composition having a charge control agent dispersed in a resin, the resin coat layer on the convex portion of the surface of a magnetic carrier core becomes thin. Because of this, charge imparting ability may sometimes decrease under a high-temperature and high-humidity environment. This is because in a thin part of the resin coat layer on the magnetic carrier surface, moisture adsorption to a magnetic carrier core having high moisture absorbency is not sufficiently suppressed and thus moisture adsorption is likely to occur with ease.

When a magnetic carrier core having convexoconcave portions on the surface is used, in order to eliminate the thin part of the resin coat layer, it is considered that the coating amount of the resin composition is increased. However, in this method, the resistivity of the magnetic carrier increases and the developability decreases accordingly.

The magnetic carrier of the present invention is constituted by coating the surface of a magnetic carrier core with a charge control agent and providing a highly resistant resin coat layer containing a resin composition thereon. By virtue of this structure, even if the resistivity of the magnetic carrier core is low, leakage can be prevented; however, toner scattering during a developing process is not inhibited. This is conceivably because even if a resin coat layer containing a resin composition has a high resistivity, a layer formed of a charge control agent capable of exchanging charges is present as an underlying layer.

Furthermore, the magnetic carrier of the present invention can suppress a reduction of charge imparting ability under a high-temperature and high-humidity environment even if a magnetic carrier core having convexoconcave portions on the surface is used. In the magnetic carrier of the present invention, the surface of a magnetic carrier core is first coated with a charge control agent, which means that a charge control agent layer capable of exchanging charges between the surface of a magnetic carrier core having a low resistance and the resin composition having a high resistance is present. By virtue of such a structure, the degree of convexoconcave on the surface is reduced by the presence of the charge control agent. In addition, by the presence of the coating layer formed of a resin composition, the thin portion of the coating resin layer can be reduced. Furthermore, by the presence of a charge control agent layer, residual charge (counter charge) of the magnetic carrier can be reduced after toner is made to fly from the magnetic carrier during the developing process.

Furthermore, the magnetic carrier of the present invention can satisfactorily impart charges to toner and suppress fogging even if it is left alone for along time. After the magnetic carrier is left alone for a long time, the charge imparting ability of the magnetic carrier is reduced. As a cause of this, it is conceived that low-molecular weight components in the resin composition have effects on the reduced charge-imparting ability. When a resin composition is used which contains a large amount of low-molecular weight components, there are present sites at which electrification is reduced in the resin coat layer, with the result that charge imparting ability of the magnetic carrier reduces and fogging sometimes occurs.

In the magnetic carrier of the present invention, a charge control agent is present under the resin coat layer. More specifically, even if low-molecular weight components are present in the resin of the resin coat layer, a reduction of electrification can be suppressed by the charge control agent. Thus, even if the magnetic carrier is left alone for a long time, fogging can be suppressed. Furthermore, if triboelectric charging is repeated within a developing unit in the time course of long-term use (running), a charge control agent is rarely worn out or removed in the magnetic carrier of the present invention. Accordingly, a reduction of a charge amount caused by abrasion and desorption of the charge control agent is prevented and thereby fogging can be suppressed.

In the magnetic carrier of the present invention, the carrier core surface is preferably covered by a charge control agent in a coverage of 70 area % or more, more preferably 90 area % or more. This is because the coverage of the carrier core surface with the charge control agent is thus enhanced, so that charges are exchanged over the entire carrier surface. Note that, how to measure the coverage by the charge control agent will be described later.

The magnetic carrier of the present invention preferably has a 50% particle size (D50) on a volume basis of 20 μm or more to 60 μm or less in view of the ability of imparting triboelectric charges to a toner, suppression of adhesion of the magnetic carrier onto an image-formed region and formation of a higher quality image.

Furthermore, the magnetic carrier of the present invention preferably has a magnetization intensity of 40 Am²/kg or more to 70 Am²/kg or less under a magnetic field of 1,000/4π (kA/m). When the magnetic carrier has a magnetization intensity of 40 Am²/kg or more to 70 Am²/kg or less, stress received by a toner in a developer magnetic brush is low, with the result that the toner is unlikely to deteriorate. Furthermore, the toner rarely adheres to a magnetic carrier. This condition is preferred. Furthermore, when the magnetization intensity is 40 Am²/kg or more to 70 Am²/kg or less, magnetic binding force is appropriately applied to a carrier on a developing sleeve. Consequently, toner is unlikely to adhere to the photosensitive member.

<Charge Control Agent>

Next, a charge control agent to be used in the magnetic carrier of the present invention will be described. Examples of the charge control agent to be used in the present invention include a nigrosine dye, a metal salt of naphthenic acid or a higher fatty acid, an alkoxylated amine, a quaternary ammonium salt compound, an azo-based metal complex, a metal salt of salicylic acid and a metal complex thereof. Of these charge control agents, a charge control agent containing a quaternary ammonium salt is preferred.

Furthermore, if the number of hydroxy groups in the quaternary ammonium salt is controlled or if a bulky substituent is used, environmental properties can be improved. As a quaternary ammonium salt, a compound represented by the following structural formula (1) is preferable.

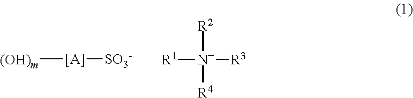

where R¹ to R⁴ each independently represent an alkyl group that may have a substituent or an aryl group that may have a substituent; R¹ to R⁴ are mutually the same or different; furthermore, [A] represents phenylene, naphthylene or anthranylene; m represents the number of hydroxy groups bonded to [A], i.e., 1 or 2.

In the present invention, the content of a charge control agent is preferably 0.1 part by mass or more to 5.0 parts by mass or less based on 100.0 parts by mass of the magnetic carrier core.

In the case where the surface of the magnetic carrier core is coated with the charge control agent by a dry-process coating, the 50% particle size (D50) of the charge control agent on a volume basis is preferably 0.1 μm or more to 20.0 μm or less. When the D50 of the charge control agent falls within the aforementioned range, a bulky charge control agent layer can be formed, with the result that charges are satisfactorily exchanged.

<Resin Composition>

Next, the resin composition to be used in the magnetic carrier of the present invention will be described.

Examples of the resin composition to be used in the present invention include polystyrene, poly(methyl methacrylate), a styrene-acrylic acid copolymer, an acrylic resin, a styrene-butadiene copolymer, an ethylene-vinyl acetate copolymer, poly(vinyl chloride), poly(vinyl acetate), a poly(vinylidene fluoride) resin, a fluorocarbon resin, a perfluorocarbon resin, a solvent-soluble perfluorocarbon resin, poly(vinyl acetal), poly(vinyl pyrrolidone), a petroleum resin, cellulose, cellulose acetate, cellulose nitrate, methylcellulose, hydroxymethylcellulose, hydroxymethylcellulose, hydroxypropylcellulose, a novolak resin, a low-molecular weight polyethylene, a saturated alkyl polyester resin, poly(ethylene terephthalate), poly(butylene terephthalate), polyarylate, an aromatic polyester resin, a polyamide resin, a polyacetal resin, a polycarbonate resin, a polyether sulfone resin, a polysulfone resin, a poly(phenylene sulfide) resin and a poly(ether ketone) resin.

To suppress toner spent, a resin composition having Tg of 70° C. or more may preferably be used. Furthermore, a resin obtained by polymerization of a monomer having a structure represented by the following formula (A1) can be used.

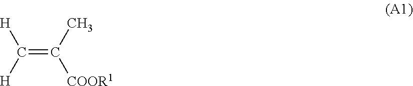

where R¹ represents an acyclic or alicyclic hydrocarbon group having 4 or more and 25 or less carbon atoms.

Furthermore, the resin composition to be used in the present invention may preferably be a copolymer obtained by polymerization of a monomer having a structure represented by Formula (A1) and a methyl methacrylate monomer. At this time, the ratio (mass ratio) of the monomers, i.e., the ratio of (monomer having a structure represented by Formula (A1)): (methyl methacrylate monomer) may preferably fall within the range of 95:5 to 60:40.

The resin composition to be used in the present invention also may preferably employ a copolymer of a cyclohexyl methacrylate monomer and a methyl methacrylate monomer. The ratio of the monomers to be polymerized may preferably fall within the range of 80:20 to 40:60.

In the resin composition to be used in the magnetic carrier of the present invention, the resin composition may contain a tetrahydrofuran (THF)-soluble content having a weight average molecular weight (Mw) of 100,000 or more and 1,000,000 or less. If the Mw of the THF-soluble content falls within the range, adhesion to a magnetic carrier core increases. As a result, if the magnetic carrier is left alone for a long time, satisfactory electrification can be obtained and fogging is favorably suppressed.

The resin composition may be prepared by use of e.g., suspension polymerization or emulsion polymerization. The resin composition obtained by suspension polymerization or emulsion polymerization is highly polymerized and has satisfactory toughness.

The molecular weight of the resin composition is controlled by changing the type of initiator, the amount of initiator, reaction temperature and reaction time, etc.

In the case where a magnetic carrier core is coated with the aforementioned resin composition by a dry-process coating apparatus, the resin composition may be formed into microparticles in a handling point of view. At this time, when the 50% particle size (D50) on a volume basis of the particles of the resin composition is set to 0.1 μm or more to 6.0 μm or less, adhesion to a magnetic carrier core can be enhanced, with the result that the magnetic carrier core can be substantially uniformly coated.

The coating amount of resin composition may preferably be 0.2 parts by mass or more and 10.0 parts by mass or less based on 100.0 parts by mass of the magnetic carrier core.

<Magnetic Carrier Core>

Next, the magnetic carrier core to be used in the present invention will be described.

As the magnetic carrier core to be used in the present invention, any one of magnetite, ferrite and a magnetic substance dispersed resin carrier core known in the art may be used as long as it is a particle having magnetism.

Of them, ferrite having voids and a resin carrier core having a magnetic substance dispersed therein may preferably be used since the true specific gravity of the magnetic carrier can be reduced. Since the true specific gravity is reduced, stress to be applied to toner is reduced and toner spent is prevented. As a process for forming a ferrite having voids, a process in which a crystal growth rate is controlled by changing temperature during baking and a process in which a void forming agent such as a foaming agent and an organic microparticle are added, can be employed.

The ferrite component contains a sintered compact of a component represented by (M1₂O)ₓ(M2O)_{y}(Fe₂O₃)_{z} where M1 is a monovalent metal atom; M2 is a divalent metal; x+y+z=1.0; x and y each satisfy 0≦(x, y)≦1.0; z satisfies 0.2<z<1.0. In the formula, Li may be mentioned as M1; a metal atom selected from the group consisting of Ni, Cu, Zn, Mg, Mn, Sr, Ca and Ba may be mentioned as M2. These metal atoms may be used alone or in combination with a few types.

Since the magnetic force and a specific resistivity of a magnetic carrier core can be satisfactorily controlled, the magnetic carrier core may preferably be ferrite containing a Mn element.

To reduce stress to be applied on a magnetic carrier within a developing unit, the true specific gravity of the magnetic carrier core may preferably be 3.2 g/cm³ or more and 5.0 g/cm³ or less.

The magnetic carrier core to be used in the present invention may preferably contain a SiO₂ component. By virtue of this, the specific gravity of the magnetic carrier core can be reduced and stress applied to the magnetic carrier within a developing unit can be reduced. As a process for adding SiO₂ to the magnetic carrier core, the processes specifically shown below can be used.

Raw materials for a ferrite component are blended in accordance with a desired composition ratio and mixed by a wet-process. After completion of the wet-process mixing, the mixture is calcined to prepare a ferrite, which is then pulverized. Examples of the pulverizer include, but not particularly limited to, a crusher, a hammer mill, a ball mill, beads mill, planet mill and jet mill. Of them, a ball mill can preferably be used since the particle size of pulverized material is easily controlled.

The 50% particle size (D50′) of the pulverized ferrite material on a volume distribution base may be 0.1 μm or more and 5.0 μm or less. By virtue of this, formation of voids and the maximum diameter and flexibility of a ferrite phase can be easily controlled by improving miscibility with SiO₂.

To the obtained pulverized ferrite material, SiO₂ is added. The weight average particle size of the SiO₂ may preferably be 1.0 μm or more and 10.0 μm or less. Furthermore, the amount of the SiO₂ added may preferably be 1 part by mass or more and 40 parts by mass or less based on 100 parts by mass of the pulverized material. The shape of the SiO₂ may preferably be spherical. When spherical SiO₂ particles having the aforementioned particle size are added, the mixing state is improved, with the result that voids are likely to be formed in the magnetic carrier core. By adding SiO₂ within the aforementioned amount, the SiO₂ content relative to the magnetic carrier core can be adjusted to fall within the range of 1 mass % to 30 mass %.

In addition to the aforementioned materials, a dispersant such as ammonium polycarboxylate, a moisturizer such as a nonionic surfactant and water are added to prepare slurry. Then, the viscosity of the slurry is controlled to adjust the final particle size of a magnetic carrier core and the size of voids.

Subsequently, the ferrite slurry of a mixture of these components is heated by a spray dryer to 100° C. or more and 300° C. or less, granulated and dried. Then, the resultant dried granulate is baked in an electric furnace of a temperature of 500 to 1,300° C. to obtain a SiO₂ component-containing magnetic carrier core.

The magnetic carrier core to be used in the present invention may preferably have an apparent density of 1.5 g/cm³ or more and 2.5 g/cm³ or less. When the apparent density of the magnetic carrier core falls within the above range, adhesion of a carrier to a photosensitive member is prevented and durability can be stably maintained. The apparent density of a magnetic carrier core can be controlled by changing the SiO₂ content, the amount of voids, shape and particle size distribution in producing the magnetic carrier core.

The apparent density of the magnetic carrier core can be obtained by a measurement apparatus in accordance with the principle of the “method of obtaining an apparent density of a material that can be poured through a regular funnel”. For example, the apparent density can be measured by a powder tester PT-R (manufactured by Hosokawa Micron Group). In the measurement, carrier core particles are supplied to a container of 20 ml in volume by use of a sieve having a mesh size of 500 μm, while vibrating the sieve with an amplitude of 1 mm, until the particles spilt from the container. The heaped carrier core particles in the container are flatten out by a stick. Based on the mass of the resultant magnetic carrier core particles, the apparent density (g/cm³) thereof is calculated.

In the magnetic carrier core of the present invention, the 50% particle size (D50) on a volume basis may be 20 μm or more and 60 μm or less because a coating treatment can be easily made.

<Production Method for Magnetic Carrier>

Next, a method for producing the magnetic carrier of the present invention will be described.

When a magnetic carrier core is coated with a charge control agent and a resin composition, a wet-process coating method and a dry-process coating method may preferably be used. Of them, a dry-process coating method is preferably used. Examples of the dry-process coating method may include a coating method in which mechanical shock is repeatedly applied and a coating method in which mechanical shock and heat are applied. Examples of an apparatus to be used in the dry-process coating method include a hybridizer (manufactured by Nara Machinery Co., Ltd.), Nobilta (manufactured by Hosokawa Micron Group), Mechanofusion (manufactured by Hosokawa Micron Group) and High Flex Gral (Earthtechnica Co., Ltd.).

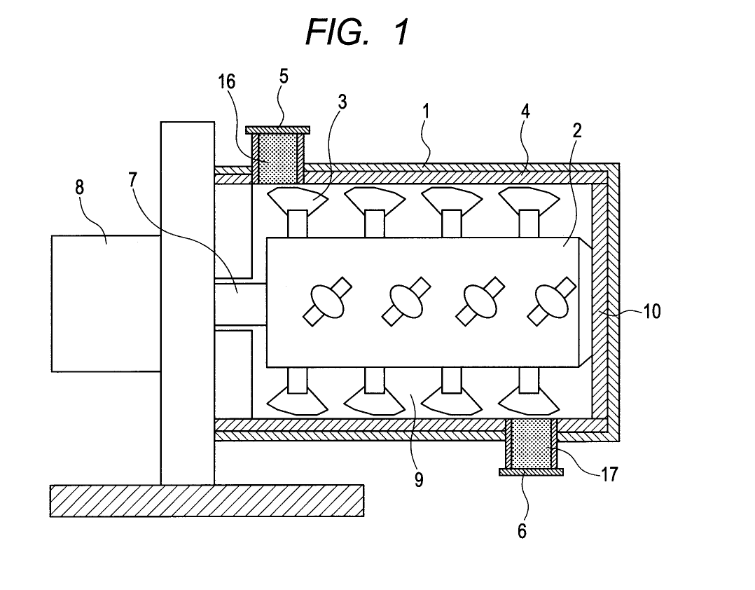

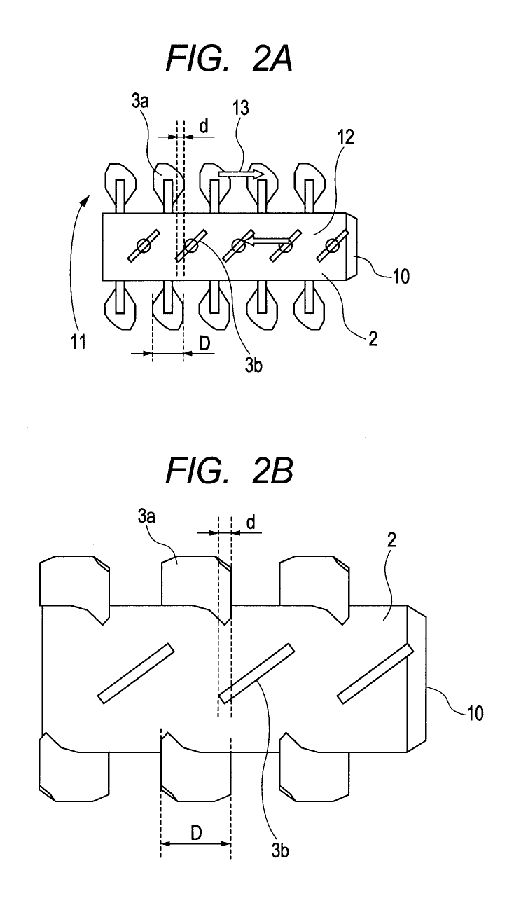

A particularly preferable apparatus is a dry-process coating apparatus shown in FIG. 1. The dry-process coating apparatus shown in FIG. 1 has a rotatory member 2, a stirring member 3, a jacket 4, a raw material inlet 5, a magnetic carrier outlet 6 and a driving section 8. The rotatory member 2 is a cylinder and rotated by the driving section 8 about a center rotation shaft 7 as a rotation shaft. On the surface of the rotatory member 2, a plurality of stirring members are arranged in rows in the direction along the rotation shaft of the rotatory member. The stirring member 3 may have a paddle shape as shown in FIG. 2A and a plate shape as shown in FIG. 2B.

As shown in FIG. 2A and FIG. 2B, a stirring member 3a and a stirring member 3b are positioned so as to overlap along the shaft direction of the center rotation shaft 7 by a width of d. The width d is defined as the width of the overlapped portion along the rotation shaft between the trace of the stirring member 3a turned around in the rotation direction and the trace of the stirring member 3b turned around in the rotation direction. In FIG. 2A and FIG. 2B, D represents the largest width (on the projection view) of a stirring member. In the case where the stirring member 3 does not have a vertically straight shape, the widest portion of the trace thereof is regarded as the overlap width d of stirring member (vane).

The rotatory member 2 rotates in the direction pointed by reference numeral 11 as shown in FIG. 2A. At this time, the stirring member 3a is inclined so as to feed a material to be processed in the direction (direction pointed by reference numeral 13) from the driving section 8 to the edge side surface 10 of the rotatory member. In contrast, the stirring member 3b is inclined in the direction opposite to the stirring member 3a so as to feed a material to be processed in the direction (direction pointed by reference numeral 12) from the edge side surface 10 of the rotatory member to the driving section 8. By virtue of the structure as mentioned, the transfer pathway of the processed material is complicated and long, a material to be processed is virtually uniformly mixed and coated. Even if the stirring member has a shape shown in FIG. 2B, it works in the same manner as above.

Note that, in a general dry-process coating apparatus, it is difficult to coat the magnetic carrier core with the charge control agent alone in the form of a layer. However, if the above apparatus is used, the magnetic carrier core can be coated with the charge control agent alone in the form of a layer without using a resin in combination. In this case, the charge control agent tightly, adheres virtually uniformly to the surface of the magnetic carrier core.

In the case where coating is performed by use of the dry-process coating apparatus shown in FIG. 1, coating time may preferably be 2 minutes or more and 60 minutes or less when a processing space 9 has an effective treatment volume of 2.0×10⁻³ m³.

In the dry-process coating apparatus shown in FIG. 1, if the driving section 8 has a rating of 5.5 kW, a power of 2.0 kW or more and 4.7 kW or less may preferably be given to a material to be processed. Furthermore, the outermost circumferential rotation speed of the stirring member 3 may preferably be controlled within the range of 5 m/sec or more and 30 m/sec or less such that the power of the driving section 8 falls within the above range.

In the dry-process coating apparatus shown in FIG. 1, the minimum clearance between the inner wall of a main-body casing 1 and the outermost end portion of the stirring member 3 may preferably be 0.5 mm or more and 30.0 mm or less.

When the magnetic carrier core is coated by use of the dry-process coating apparatus shown in FIG. 1, the following procedure may be employed.

First, an inner piece 16 for a raw material inlet is taken out from the raw material inlet 5 and a magnetic carrier core is loaded through the raw material inlet 5. Then, a charge control agent is loaded and the inner piece 16 for a raw material inlet is inserted and then the inlet is closed airtight. The magnetic carrier core and charge control agent loaded are stirred and mixed by a plurality of stirring members 3 provided on the surface of the rotatory member 2. In this manner, the magnetic carrier core is coated. Note that, as the order of materials to be loaded, the charge control agent may preferably be first loaded through the raw material inlet 5 and then the magnetic carrier core may be loaded. Furthermore, the magnetic carrier core and the charge control agent are previously mixed by a mixer such as the Henschel mixer and then, the mixture may be loaded through the raw material inlet 5 of the apparatus shown in FIG. 1 to perform a coating process.

After completion of coating, the inner piece 16 for a raw material inlet is taken out from the raw material inlet 5 and a resin-composition particle is loaded through the raw material inlet 5. The inner piece 16 for a raw material inlet is loaded and then the inlet is closed airtight. Subsequently, the magnetic carrier core coated with a charge control agent and the resin-composition particle are stirred and mixed by a plurality of stirring members 3 provided on the surface of the rotatory member 2. In this manner, a coating process is performed.

Note that, to control the temperature of a material to be processed during coating, the rotatory member 2 and a main-body casing 1 having a jacket 4 through which a cold heat-medium can flow may preferably be used. As the cold heat-medium, a fluid such as cooling chiller water, hot water, steam and oil can be used.

After completion of coating with a resin composition, an inner piece 17 for a magnetic carrier outlet within the magnetic carrier outlet 6 is taken out. The rotatory member 2 is rotated by the driving section 8 to discharge a magnetic carrier from the magnetic carrier outlet 6. The magnetic carrier discharged is selected by magnetic force, if necessary, the residual resin-composition particle is separated with a sieve such as a circler vibration sieving machine to obtain a magnetic carrier.

<Two-Component Developer>

The two-component developer of the present invention contains a toner and a magnetic carrier. The toner to be used in the two-component developer of the present invention will be described below.

The toner may preferably have a weight average particle size (D4) of 3.0 μm or more and 8.0 μm or less. when the weight average particle size (D4) falls within the above range, the flowability of the toner is satisfactory, and a sufficient charge amount and a satisfactory resolution can be easily obtained. When the toner having a weight average particle size (D4) within the above range and the magnetic carrier of the present invention are used in combination, electrostatic property and flowability of a developer can be appropriately controlled. As a result, transportability of the two-component developer on a developer carrier is improved, and, additionally, a toner can be satisfactorily removed from a magnetic carrier and an excellent developability can be obtained.

The toner may be produced by either a pulverization process or a process for producing a toner particle in an aqueous medium, such as a suspension polymerization process and an emulsion aggregation process.

The binder resin to be used in a toner may preferably have a weight average molecular weight (Mw) (measured by gel permeation chromatography (GPC)) of 2,000 or more and 1,000,000 or less and a glass transition point (Tg) of 40° C. or more and 80° C. or less in order to keep storage stability and low-temperature fixation property of the toner in balance.

The toner may contain wax. The use amount of wax may preferably be 0.5 to 20 parts by mass based on 100 parts by mass of the binder resin. As the temperature of the maximum endothermic peak of a wax may preferably be 45° C. or more and 140° C. or less in view of keeping storage stability and hot offset resistance of the toner in balance.

Examples of wax include a hydrocarbon wax such as paraffin wax and Fischer-Tropsch wax; a wax containing aliphatic acid ester as a main component, such as carnauba wax, behenyl behenate, montanic acid ester wax; and wax obtained by deoxidating a part or whole aliphatic acid ester, such as deoxidated carnauba wax.

The toner may contain a charge control agent. As the charge control agent, an organic metal complex, a metal salt and a chelate compound are mentioned. Examples of the organic metal complex include a monoazo metal complex, an acetylacetone metal complex, a hydroxycarboxylic acid metal complex, a polycarboxylic acid metal complex and a polyol metal complex. Other examples thereof include a carboxylic acid derivative such as a metal salt of a carboxylic acid, an anhydride of a carboxylic acid and a carboxylic acid ester; and a condensation product of an aromatic compound. Furthermore, a bisphenol and a phenol derivative such as calixarene can be used as the charge control agent. Of them, a metal compound of an aromatic carboxylic acid is preferably used in view of improving initial rise of triboelectric charging of a toner. The content of a charge control agent may preferably be 0.1 to 10.0 parts by mass based on 100 parts by mass of the binder resin in order to obtain a stable amount of triboelectric charges in an environment from high-temperature and high-humidity to low-temperature and low-humidity.

The content of the colorant to be used in a toner may preferably be 0.1 to 20.0 parts by mass based on 100.0 parts by mass of the binder resin in view of dispersibility and chromogenic property of the colorant.

The toner may contain an external additive to improve fluidity. As the external additive, an inorganic fine powder such as silica, titanium oxide and aluminum oxide can be used. The inorganic fine powder may be hydrophobized with a hydrophobizing agent such as a silane compound, silicone oil or a mixture of these. The external additive can be used in an amount of 0.1 part by mass or more and 5.0 parts by mass or less based on the toner particle (100 parts by mass).

To the toner, a spacer particle can be added as an external additive in order to enhance mold release characteristics of the toner and the carrier. As the spacer particle, a silica particle obtained by a sol-gel process may be used. The silica particles obtained by the sol-gel process has a uniform particle size. Furthermore, the silica particles obtained by the sol-gel process may have one or more maximum values within the range of 80 nm or more and 200 nm or less in the particle size distribution on number basis.

Note that, the sol-gel process is a process for obtaining silica particles by hydrolyzing and condensing an alkoxy silane in an organic solvent containing water in the presence of a catalyst to obtain a silica sol suspension solution and further removing the solvent followed by drying.

The content of the silica produced by the sol-gel process can be 0.1 part by mass or more and 5.0 parts by mass or less based on the toner particle (100 parts by mass) because it works more effectively as a spacer particle.

When a two-component developer is prepared by blending a magnetic carrier and a toner, the blending ratio can be 2 mass % or more and 15 mass % or less in terms of the concentration of a toner in the developer.

Next, measurement methods for physical properties used in the present application will be described below.

<Measurement Method for the Molecular Weight of the Resin Composition>

The molecular weight distribution of a tetrahydrofuran (THF)-soluble matter of a resin composition is measured by gel permeation chromatography (GPC) as follows.

First, a resin composition is dissolved in tetrahydrofuran (THF) at 23° C. over 24 hours. Then, the obtained solution is filtrated by a solvent-resistant membrane filter “Maeshori disk” (manufactured by Tohso Corporation) having a pore diameter of 0.2 μm to obtain a sample solution.

Note that, the sample solution is controlled such that the concentration of the THF-soluble component becomes 0.8 mass %. Measurement is performed by using this sample solution in the following conditions.

Apparatus: HLC8120 GPC (detector: RI)(manufactured by Tohso Corporation)
Column: A series of 7 columns: Shodex KF-801, 802, 803, 804, 805, 806, 807 (manufactured by Showa Denko K. K.)
Eluting solution: Tetrahydrofuran (THF)
Flow rate: 1.0 ml/min
Oven temperature: 40.0° C.
Sample loading amount: 0.10 ml

In calculating the molecular weight of a sample, a molecular weight calibration curve prepared by using a standard polystyrene resin is used. As the standard polystyrene resin, the following examples are mentioned.

Specifically, TSK standard polystyrene F-850, F-450, F-288, F-128, F-80, F-40, F-20, F-10, F-4, F-2, F-1, A-5000, A-2500, A-1000, A-500 (manufactured by Tohso Corporation) are mentioned.

<Measurement Method for True Specific Gravity of Magnetic Carrier Core>

The true specific gravity of a magnetic carrier core is measured by use of a dry-process automatic density meter, Accupyc 1330 (manufactured by Shimadzu Corporation).

First, 5 g of a sample, which is left alone in an environment of 23° C., 50% RH for 24 hours, is weighed, placed in a measurement cell (10 cm³) and loaded in a sample chamber of a main machine. The weight of the sample is input in the main machine and then measurement is started. In the measurement, the sample chamber is purged 10 times with helium gas adjusted to 20.000 psig (2.392×10² kPa). Subsequently, helium gas is repeatedly purged until the pressure reaches an equilibrium state where the pressure change within the sample chamber reaches 0.005 psig/min (3.447×10⁻² kPa/min). Then, the pressure of the sample chamber of the main machine at the equilibrium state is measured. Based on the pressure change when the pressure reaches the equilibrium state, the volume of the sample can be calculated. The true specific gravity of the sample is calculated in accordance with the following expression.

True specific gravity of a sample(g/cm³)=sample mass (g)/sample volume(cm³)

The measurement as mentioned above is repeated 5 times and the resultant true specific gravity values of the sample are averaged. The average value is regarded as the true-specific gravity of the magnetic carrier core (g/cm³).

<Measurement Method for 50% Particle Size (D50) on a Volume Basis of Resin-Composition Particle>

In the case where a resin composition is used in the form of a particle, 50% particle size (D50) on a volume basis is measured by a particle-size distribution measuring apparatus “Microtrack MT3300EX” (manufactured by Nikkiso Co., Ltd.) of a laser diffraction/scattering system. To this apparatus, a wet-process sample circulator “Sample Delivery Control (SDC)” (manufactured by Nikkiso Co., Ltd.) is equipped. Ion-exchange water is allowed to circulate in the sample circulator, to which a resin composition is dropwise added so as to obtain a measurable concentration. Measurement is performed at a flow rate of 70%, an ultrasonic power of 40 W and an ultrasonic application time of 60 seconds. Control and calculation method of D50 are automatically performed by use of software in the following conditions. As the particle size, a cumulative value on a volume basis, i.e., 50% particle size (D50), is obtained.

Measurement conditions are as follows.

Set Zero time: 10 seconds
Measurement time: 30 seconds
Measurement times: 10 times
Solvent refractive index: 1.33
Particle refractive index: 1.50
Particle shape: Non-spherical shape
Measurement upper limit: 1408 μm
Measurement lower limit: 0.243 μm
Measurement environment: Normal-temperature and normal-humidity environment (23° C., 50% RH)

<Measurement Method for 50% Particle Size (D50) on a Volume Basis of Magnetic Carrier and Magnetic Carrier Core>

Measurement of particle size distribution is performed by use of a laser diffraction/scattering system particle-size distribution measuring apparatus “Microtrack MT3300EX” (manufactured by Nikkiso Co., Ltd.). To the apparatus, a sample supplier for a dry-process measurement, “one-shot dry type sample conditioner, Turbotrac” (manufactured by Nikkiso Co., Ltd.) is equipped. The Supply conditions by Turbotrac are: a dust collector used as a vacuum source, air volume of about 33 liter/sec and pressure of about 17 kPa. Then, 50% particle size (D50), which is a cumulative value on a volume basis, is obtained. Control and analysis are performed by use of the accompanying software (version 10.3.3-202D). Measurement conditions are as follows:

Set Zero time: 10 seconds
Measurement time: 10 seconds
Measurement times: Once
Particle refractive index: 1.81
Particle shape: Non-spherical shape
Measurement upper limit: 1408 μm
Measurement lower limit: 0.243 μm
Measurement environment: Normal-temperature and normal-humidity environment (23° C., 50% RH)

<Measurement Method for Magnetization Intensity of Magnetic Carrier and Magnetic Carrier Core>

The magnetization intensity of magnetic carrier and magnetic carrier core can be measured by an oscillating field type magnetic property apparatus VSM (vibrating sample magnetometer) or a direct-current magnetization property recording apparatus (B-H tracer).

Preferably, the oscillating field type magnetic property apparatus is used. As the oscillating field type magnetic property apparatus, an oscillating field type magnetic property automatic recording apparatus BHV-30 manufactured by Riken Denshi Co., Ltd. can be mentioned. In Examples herein, measurement was made by use of this apparatus in accordance with the following procedure.

A cylindrical plastic container is sufficiently charged with a magnetic carrier or a magnetic carrier core and an external magnetic field of 1000/4π (kA/m) is created. In this state, the magnetization moment of a magnetic carrier charged in the container is measured. Further, the true mass of the magnetic carrier or magnetic carrier core charged in the container is measured to obtain a magnetization intensity (Am²/kg) of the magnetic carrier or the magnetic carrier core.

<Measurement Method for Coverage of the Surface of a Magnetic Carrier Core with a Charge Control Agent>

On the sample holder of an electron microscope, a magnetic carrier core coated with a charge control agent (hereinafter also referred to as a CA coated particle) is fixed by carbon tape so as to form a single layer. The magnetic carrier core is observed by a scanning electron microscope S-4800 (manufactured by Hitachi, Ltd.) in the following conditions without vapor deposition with platinum. Observation is made after a flashing operation.

### SignalName ═SE (U, LA80)

### AcceleratingVoltage=2000 Volt

### EmissionCurrent=10000 nA

### WorkingDistance=6000 um

### LensMode=High

### Condencer1=5

### ScanSpeed=Slow4 (40 sec.)

### Magnification=600

### DataSize=1280×960

### ColorMode=Grayscale

The luminosity of a reflection electron image is set to “contrast 5, brightness −5” by use of control software of a scanning electron microscope S-4800, and a projection image of the magnetic carrier is obtained as a 8 bit, 256 gradation gray-scale image having an image size of 1280×960 pixels at a capture speed/cumulated numbers of sheets “Slow 4 for 40 seconds”. Using the scale on the image, the length of 1 pixel is regarded as 0.1667 μm and the area of 1 pixel is regarded as 0.0278 Am².

Using the projection image obtained, the ratio (area %) of a high brightness area of the CA coated particle relative to the projection area of the CA coated particle is calculated in the manner as shown below. Analysis is made by use of image processing software, Image-ProPlus 5.1J (manufactured by Media Cybernetics).

First, in the projection image, in order to extract the CA coated particle to be analyzed, the CA coated particle is separated from the background portion. For this, “Measurement”-“count/size” of Image-Pro Plus5.1J is selected. In the “count/size”, “brightness range selection” the brightness range is set to 50 to 255. In this manner, the background carbon-tape portion having a low brightness is eliminated to extract the CA coated particle. In extracting the CA coated particles, in the extraction option of the “count/size”, “4 links” is selected and then “smoothness 5” is input and a check mark is placed in “hole is buried”. Particles present on the boarder (outer circumference) and particles overlapped with other particles should be eliminated from calculation. Subsequently, in the measurement items “count/size”, “area” and “Feret's diameter” (average) are selected and the “screening range of area” is set to 300 pixels in a minimum and 10,000,000 pixels in maximum. Furthermore, the “screening range of the Feret's diameter (average)” is set so as to correspond to ±25% of 50% particle size (D50) measurement value on a volume basis of a magnetic carrier core as mentioned above. In this manner, CA coated particles subjecting to image analysis are extracted. A single particle is selected from a group of the extracted particles and projection area ja (on a pixel number basis) of the particle is obtained.

Next, in Image-Pro Plus5.1J, “count/size”, “brightness range selection”, a brightness range is set to 140 to 255, a high-brightness portion of the CA coated particle is extracted. The screening range of the area is set to be from 10 pixels in a minimum and 10,000 pixels in maximum. The high-brightness portion of the CA coated particle is a part not sufficiently covered with a charge control agent. Then, with respect to the particle selected for obtaining ja, the area ma (on a pixel number basis) of the high-brightness portion of the surface of the CA coated particle is obtained. In each CA coated particle, high-brightness portions having a certain size are scattered. The “ma” is the total area of the portions.

Next, the same operation is repeated with respect to each CA coated particle of the extracted-particle group until the number of CA coated particles reaches 50. When the number of particles in a single viewing field is less than 50, the same operation is repeated with respect to a CA coated particle projection image in another viewing field. Provided that the total ma value of 50 particles is represented by Ma, and the total ja value of 50 particles is represented by Ja, the coverage Av₁ (area %) of the surface of a magnetic carrier core with a charge control agent can be calculated in accordance with the following expression.

Av₁=100−(Ma/Ja)×100

<Measurement Method for Weight-Average Particle Size (D4) of Toner and Toner Particle>

The weight-average particle size (D4) of toner and a toner particle is obtained by use of an accurate particle size distribution measuring apparatus “Coulter counter Multisizer 3” (registered trade mark, manufactured by Beckman Coulter, Inc.) equipped with a 100-μm aperture tube and based on the pore electrical resistance method.

Further, to set measurement conditions and analyze measurement data, the accompanying special software “Beckman Coulter Multisizer 3 Version 3.51” (manufactured by Beckman Coulter, Inc.) is used. Effective measurement channels of 25,000 in number are used for measuring particle sizes and obtained data are analyzed to computationally obtain D4. As the aqueous electrolyte solution to be used in measurement, a special-grade sodium chloride dissolved in ion-exchange water up to a concentration of about 1 mass %, for example, “ISOTON II” (manufactured by Beckman Coulter, Inc.) can be used.

Before measurement and analysis are performed, settings of a special software are made as follows. In the special software, on the screen of “Change of Standard of Measurement (SOM)”, the total count number in the control mode is set to 50000 particles, the number of measurement times is set to 1. As a Kd value, the value obtained by using “standard particle 10.0 μm” (manufactured by Beckman Coulter, Inc.) is set. The threshold and noise level are automatically set by pressing a “threshold and noise level measurement” button. Furthermore, the current is set to 1600 μA, gain is set to 2, the electrolyte is set to ISOTON II, a check mark is placed in “flash aperture tube after measurement”.

In the screen of “setting change from pulse to particle size” in the special software, the bin interval is set to a logarithmic particle size, the particle-size bin to a 256 particle size bin, and the particle-size range is set to 2 μm or more and 60 μm or less. The measurement is specifically performed in accordance with the following method.

(1) To a 250 ml glass beaker with a round bottom for exclusive used for Multisizer 3, the above aqueous electrolyte solution (about 200 ml) is placed. The beaker is set in a sample stand (holder) and the solution was stirred by using and operating a stirrer rod counterclockwise at a rate of 24 rounds/second. Then, using the function “flush aperture” of the analysis software, stains within an aperture tube and air bubbles are removed.

(2) To a 100 ml glass beaker with a flat bottom, the above aqueous electrolyte solution (about 30 ml) is placed. To the solution, about 0.3 ml of a three-fold (by mass) dilution solution of “Contaminon N” (a 10 mass % aqueous solution of a neutral detergent (pH7) for a precision measuring instrument washing containing a nonionic surfactant, an anionic surfactant and organic builder; manufactured by Wako Pure Chemical Industries Ltd.) with ion-exchange water is added as a dispersant.

(3) In a water vessel equipped with an ultrasonic wave dispersion system “Ultrasonic Dispension System Tetora 150” (manufactured by Nikkaki Bios Co., Ltd.) in which two oscillators each having an oscillating frequency of 50 kHz are installed with the phases shifted by 180° and an electric power of 120 W, and a predetermined amount of ion-exchange water is placed. To the water vessel, about 2 ml of the aforementioned Contaminon N is added.

(4) The beaker mentioned in the above (2) is set in a beaker fixation hole of the ultrasonic wave dispersion system, and the ultrasonic wave dispersion system is turned on. The vertical position of the beaker is adjusted such that the resonance state of the liquid surface of the aqueous electrolyte solution in the beaker reaches a maximum

(5) While the aqueous electrolyte solution of the beaker mentioned in the above (4) is irradiated with ultrasonic wave, a toner (about 10 mg) is added little by little to the aqueous electrolyte solution and dispersed and further a dispersion treatment with ultrasonic wave is continued for 60 seconds. Note that, during dispersion with ultrasonic wave, the water temperature of the water vessel is appropriately controlled so as to be 10° C. or more and 40° C. or less.

(6) To the beaker mentioned in the above (1) with a round bottom set in the sample stand (holder), the aqueous electrolyte solution mentioned in the above (5) having a toner dispersed therein is added dropwise by a pipette to adjust a measurement concentration to be about 5%. Subsequently, measurement is performed until the number of the measured particles reaches 50000.

(7) Measurement data is analyzed by the special software attached to the apparatus to computationally obtain a weight average particle size (D4). Note that, if “graph/vol. %” is set in the special software (“Multisizer 3 Version 3.51” manufactured by Beckman Coulter, Inc.), the “average size” is displayed on the “analysis value/volume statistic value (arithmetic average)” screen. This is the weight average particle size (D4).

<Measurement of the Glass Transition Point (Tg) of Resin Composition>

The glass transition point (Tg) of a resin composition is measured by a differential scanning calory analyzer “Q1000” (manufactured by TA Instruments) in accordance with ASTM D3418-82. Temperature correction in the apparatus detection section is made by using melting points of indium and zinc, whereas calory correction is made by using heat-of-fusion of indium. To describe more specifically, a resin composition (about 10 mg) is weighed and placed in an aluminum pan. As a reference, a vacant aluminum pan is used. Measurement is performed within the range of 30 to 200° C. while raising the temperature at a rate of 10° C./min. During the temperature raising process, variation of specific heat occurs within a temperature range of 40° C. to 100° C. The intersection between the line drawn through the middle point of base lines before and after variation of specific heat occurs and the differential thermal (analysis) curve is specified as the glass transition temperature Tg of the resin composition.

<Measurement Method of Toner Load and Charge Amount on Photosensitive Drum>

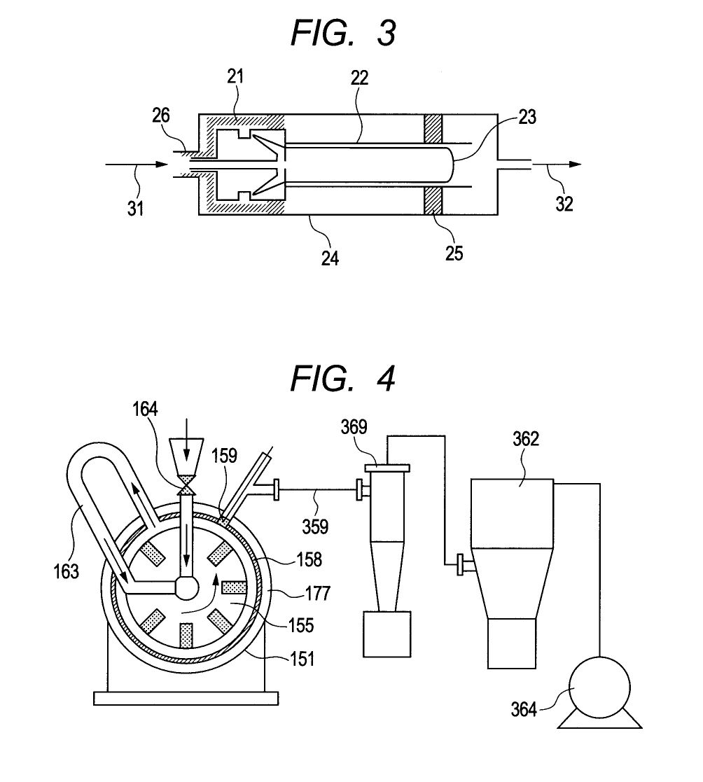

Toner on a photosensitive drum is collected by suction using a metal cylinder tube and a cylindrical filter and toner load is calculated. Atoner triboelectric charge amount and toner load on the photosensitive drum can be measured by the Faraday-Cage shown in FIG. 3. Faraday-Cage refers to a coaxial double cylinder in which an inner cylinder 22 and an outer cylinder 24 are insulated by insulating members 21 and 25. If a charged body having charge amount Q is placed in the inner cylinder 22, electrostatic induction occurs, thereby creating a situation as if a metal cylinder having charge amount Q is present in the metal cylinder.

First, a toner image developed on a photosensitive drum is suctioned by the Faraday-Cage. A suction port 26 is allowed to be contact with the toner image on the photosensitive drum and toner on the photosensitive drum is suctioned by a suction machine (not shown) in the direction pointed by arrows 31, 32. The suctioned toner is collected by a cylindrical filter (cylinder filter) 23 arranged within the inner cylinder 22.

The amount of charge Q (mC) induced at this time is measured by an electro meter (Keithley 6517A, manufactured by Keithley Instruments Inc.)(not shown). Subsequently, the amount of charge Q (mC) is divided by toner mass M (kg) in the inner cylinder 22 to obtain a toner charge amount Q/M (mC/kg) on the photosensitive drum.

Furthermore, the toner image developed on the photosensitive drum is suctioned by the Faraday-Cage. Toner is suctioned by bringing the suction port 26 into contact with the portion on the photosensitive drum in which a toner image is present. Toner (a length of about 10 cm) along the longitudinal direction of the photosensitive drum is suctioned. At this time, the width (corresponding to the diameter of the suction port) and the length are measured and multiplied to obtain area S. The mass M (mg) of toner suctioned is divided by the area S (cm²) of the toner suctioned to obtain a toner load M/S (mg/cm²) per unit area.

### EXAMPLES

### Production Example of Magnetic Carrier Core a

To a mixture of Fe₂O₃ (70 parts by mass) and MnCO₃ (30 parts by mass), water was added and mixed by a ball mill in a wet-process. After the wet-process mixing, the mixture was calcined at a temperature of 900° C. for 2 hours to prepare ferrite. The ferrite prepared was crushed by a crusher into pieces of 0.1 mm or more and 1.0 mm or less and then water was added thereto and further pulverized by a ball mill into fine pieces of 0.1 μm or more and 0.5 μm or less to obtain ferrite slurry. Next, spherical SiO₂ (20.0 parts by mass) having a weight average particle size of 4.0 μm relative to the pulverized ferrite material (100.0 parts by mass) in the slurry, was added. Furthermore, polyvinyl alcohol (2.0 parts by mass) as a binder, poly(ammonium carboxylate) (Nopcosperse 5600 manufactured by San Nopco Limited)(1.5 parts by mass) as a dispersant and a nonionic surfactant (0.05 parts by mass) as a moisturizer were added.

The slurry containing the aforementioned materials was granulated and dried by a spray dryer (manufactured by Ohkawara Kakohki Co., Ltd.) to obtain granulates. The obtained granulates were baked in an electric furnace of a temperature of 1150° C. for 5 hours under a nitrogen atmosphere having an oxygen concentration of 1.0%. After the baking, the granulates were crushed by a hammer mill. Coarse particles were removed by a sieve having a mesh size of 74 μm and fine powder particles was removed by a wind-power classifier (Elbow jet EJ-LABO manufactured by Nittetsu Mining Co., Ltd.) to obtain magnetic carrier core a. The physical properties of the resultant magnetic carrier core a are shown in Table 1.

### Production Example of Magnetic Carrier Core b

Magnetic carrier core b was obtained in the same manner as in Production Example of magnetic carrier core a except that SiO₂ was not added. The physical properties of the resultant magnetic carrier core b are shown in Table 1.

### Production Example of Magnetic Carrier Core c

Magnetite microparticle 1 (spherical, number average particle size: 250 nm, magnetization intensity: 65 Am²/kg) and magnetite microparticle 2 (spherical, number average particle size: 500 nm, magnetization intensity: 66 Am²/kg) were introduced in a container. Further, a silane-based coupling agent (3-(2-aminoethylaminopropyl)trimethoxysilane)(3.0 mass % based on the total mass of magnetite microparticle 1 and magnetite microparticle 2) was introduced into the container. In the container, the mixture was mixed while stirring at a high speed at a temperature of 100° C. or more to treat the surface of a magnetite microparticle.

Phenol: 10 parts by mass
Formaldehyde solution (37 mass % aqueous formaldehyde solution): 16 parts by mass
Surface-treated magnetite microparticle 1: 59 parts by mass
Surface-treated magnetite microparticle 2: 25 parts by mass

The aforementioned materials were introduced in a reaction pot and sufficiently mixed at a temperature of 40° C. Thereafter, the mixture was heated at an average temperature raising rate of 3° C./minute while stirring to a temperature of 85° C., 28 mass % ammonia water (4 parts by mass) and water (45 parts by mass) were added to the reaction pot. The mixture was maintained at a temperature of 85° C. for 3 hours to undergo a polymerization reaction, thereby hardening it.

After the polymerization reaction, the resultant material was cooled to a temperature of 30° C. and water was added thereto. After the supernatant was removed and the resultant precipitate was washed with water and further dried with air. The resultant air-dried material was further dried at a temperature of 60° C. under reduced pressure (0.5 kPa or less).

The resultant dry product was crushed by a hammer mill and coarse particles were removed by a sieve having a mesh size of 74 μm and fine powder particles were removed by a wind-power classifier (Elbow jet EJ-LABO manufactured by Nittetsu Mining Co., Ltd.) to obtain magnetic carrier core c. The physical properties of the resultant magnetic carrier core c are shown in Table 1.

### Production Example of Magnetic Carrier Core d

Magnetic carrier core d was obtained in the same manner as in Production Example of magnetic carrier core b except that a granulated product was baked under a nitrogen atmosphere having an oxygen concentration of 3.0% in an electric furnace of 1350° C. in temperature for 5 hours in Production Example of magnetic carrier core b. The physical properties of the resultant magnetic carrier core d are shown in Table 1.

TABLE 1

| | | | | | True | | |
|---|---|---|---|---|---|---|---|
| | SiO₂ | Oxygen | Baking | | specific | Apparent | Intensity of |
| Magnetic | addition amount | concentration | temperature | D50 | weight | density | magnetization |
| carrier core | (parts by mass) | (%) | (° C.) | (μm) | (g/cm³) | (g/cm³) | (Am²/kg) |
| a | 20 | 1.0 | 1150 | 33 | 3.74 | 1.81 | 50 |
| b | 0 | 1.0 | 1150 | 34 | 4.84 | 1.89 | 62 |
| c | 0 | — | — | 48 | 3.58 | 1.98 | 54 |
| d | 0 | 3.0 | 1350 | 35 | 4.86 | 2.44 | 60 |

### Production Example of Resin Composition 1

In ion-exchange water (900 parts by mass), poly(oxypropylene glycol) (15 parts by mass) was dissolved. To this, cyclohexyl methacrylate (75 parts by mass) and methyl methacrylate (25 parts by mass) were added and mixed. The mixture was increased in temperature to 80° C. while further stirring under a nitrogen atmosphere. To this monomer composition reaction solution, 1 part by mass of 2,2′-azobis(2,4-dimethylvaleronitrile) was added and the reaction was performed at a temperature of 80° C. for 10 hours. After completion of the polymerization reaction, a residual monomer was distilled away under reduced pressure. After cooled, the resultant mixture was filtrated, washed with water, dried and crushed.

Next, coarse particles were removed by a sieve having a mesh size of 74 μm to obtain particles of resin composition 1. The physical properties of the particles of the resultant resin composition 1 are shown in Table 2.

### Production Examples of Resin Compositions 2 and 3

In ion-exchange water (900 parts by mass), sodium dodecylbenzenesulfonate (2 parts by mass) was dissolved and cyclohexyl methacrylate (80 parts by mass) and methyl methacrylate (20 parts by mass) were introduced and mixed and further increased in temperature to 80° C. while stirring under a nitrogen atmosphere.

A polymerization initiator, potassium persulfate (0.3 parts by mass) dissolved in ion-exchange water (5 parts by mass) was added to the monomer composition reaction solution and reacted at a temperature of 80° C. for 10 hours. After completion of the polymerization reaction, a residual monomer was distilled away under reduced pressure. After cooled, the resultant mixture was filtrated, washed with water, dried and crushed. Then, coarse particles were removed by a sieve having a mesh size of 74 μm to obtain particles of resin composition 2.

Furthermore, the particle of resin composition 3 was obtained in the same manner as in the particle of resin composition 2 except that the ratio of cyclohexyl methacrylate and methyl methacrylate was changed as shown in Table 2, the amount of sodium dodecylbenzenesulfonate was changed to 1.5 parts by mass during resin-composition particle production time, and the addition amount of polymerization initiator and polymerization time were controlled.

The physical properties of particles of the resultant resin compositions 2 and 3 are shown in Table 2.

### Production Example of Resin Composition 4

To a four-neck separable flask equipped with a stirrer, a condenser, a thermometer and a nitrogen introduction pipe, toluene (100 parts by mass) and methyl ethyl ketone (100 parts by mass) were charged as a solvent. Further, a methyl methacrylate monomer (80 parts by mass), a cyclohexyl methacrylate monomer (20 parts by mass) and azobisisovaleronitrile (0.5 parts by mass) as a polymerization initiator were charged. The resultant mixture was directly subjected to a solution polymerization reaction for 5 hours while stirring and introducing nitrogen at 80° C. to obtain a polymerization solution.

Thereafter, impurities were removed by a sieve having a mesh size of 20 μm to obtain the solution of resin composition 4 (solid substance: 33 mass %). The physical properties of the resultant resin composition 4 are shown in Table 2.

### Production Example of Resin Composition 5

The particle of resin composition 2 (98 parts by mass) and a titanium oxide particle (1 part by mass) having a number average particle size of 40 nm were mixed by the Henschel mixer to prepare resin composition 5. D50 was 0.1 μm.

TABLE 2

| | | | Polymerization | | | Weight | |
|---|---|---|---|---|---|---|---|
| | | | initiator | | | average | |
| | | | addition | Polymerization | | molecular | |
| Resin | | | amount (parts | temperature | Polymerization | weight Mw | D50 |
| composition | Composition | | by mass) | (° C.) | time (hour) | (×10⁴) | (μm) |
| 1 | Cyclohexyl | Methyl | 1.0 | 80 | 10 | 48.6 | 2.3 |
| | methacrylate | methacrylate | | | | | |
| | 75 parts by | 25 parts by | | | | | |
| | mass | mass | | | | | |
| 2 | Cyclohexyl | Methyl | 0.3 | 80 | 10 | 162.0 | 0.1 |
| | methacrylate | methacrylate | | | | | |
| | 80 parts by | 20 parts by | | | | | |
| | mass | mass | | | | | |
| 3 | Cyclohexyl | Methyl | 0.5 | 80 | 15 | 99.1 | 0.3 |
| | methacrylate | methacrylate | | | | | |
| | 40 parts by | 60 parts by | | | | | |
| | mass | mass | | | | | |
| 4 | Cyclohexyl | Methyl | 0.5 | 80 | 5 | 5.4 | — |
| | methacrylate | methacrylate | | | | | |
| | 20 parts by | 80 parts by | | | | | |
| | mass | mass | | | | | |

(Charge Control Agents 1 to 4)

As charge control agent 1, Bontron P-51 (trade name, manufactured by Orient Chemical Industries Co., Ltd.) was used. Furthermore, as charge control agents 2 to 4, compounds represented by the following formula (2) where m, A, R¹, R², R³, R⁴ are specified as shown in Table 3 were used.

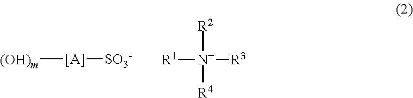

TABLE 3

| Charge | | | | | | |
|---|---|---|---|---|---|---|
| control | | | | | | |
| agent | m | A | R¹ | R² | R³ | R⁴ |
| 1 | 1 | Naphthylene | Phenyl | C₄H₉ | C₄H₉ | C₄H₉ |
| 2 | 1 | Naphthylene | C₄H₉ | C₄H₉ | C₄H₉ | C₄H₉ |
| 3 | 1 | Naphthylene | Phenyl | Phenyl | C₄H₉ | C₄H₉ |
| 4 | 2 | Naphthylene | Phenyl | C₄H₉ | C₄H₉ | C₄H₉ |

(Charge Control Agent 5)

As charge control agent 5, a compound represented by the following formula (3) was used.

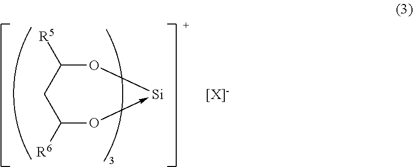

where R⁵ and R⁶ each represent a C₄H₉ group, X represents 2-ethylhexylsulfuric acid ester ion.

(Charge Control Agent 6)

As charge control agent 6, a compound represented by the following formula (4) was used.

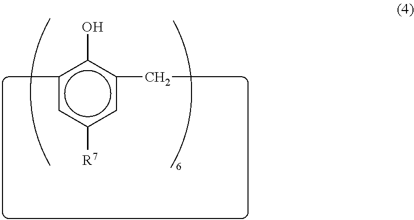

where R⁷ is a C₄H₉ group

(Charge Control Agent 7)

As charge control agent 7, a compound represented by the following formula (5) was used.

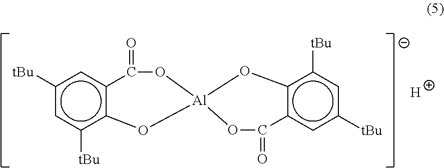

### Production Example of Magnetic Carrier A

As the primary coating process, the inner piece 16 for a raw material inlet was taken out from the raw material inlet 5 of the apparatus shown in FIG. 1, magnetic carrier core a (100 parts by mass) was introduced through the raw material inlet 5. Next, charge control agent 1 (0.2 parts by mass) was introduced and the inner piece 16 for a raw material inlet was inserted and the inlet was closed airtight.

Note that, in the apparatus shown in FIG. 1, the effective volume of a process space 9 was 2.0×10⁻³ m³, and the rating power of the driving section 8 was set to 5.5 kW.

While the outermost circumferential speed of the stirring member 3 was controlled to be 10 m/sec such that a load power became constant at 3.5 kW, coating was performed for 10 minutes. Thereafter, to measure the coverage of a charge control agent, 0.1 g of a particle coated with a charge control agent was taken out from the inlet.

To perform second coating, while a particle coated with a charge control agent was placed in a process apparatus, the inner piece 16 for a raw material inlet was taken out from the raw material inlet 5, a particle of resin composition 1 (1.0 part by mass) was introduced through the raw material inlet 5. Then, the inner piece 16 for a raw material inlet was inserted and the inlet was closed airtight.

While the outermost circumferential speed of the stirring member 3 was controlled to be 10 m/sec such that a load power became constant at 3.5 kW, a coating process was performed for 10 minutes.

After completion of the coating process, the inner piece 17 for a magnetic carrier outlet within the magnetic carrier outlet 6 was taken out and the rotatory member 2 was rotated by the driving section 8, and a magnetic carrier was discharged from the magnetic carrier outlet 6. The obtained magnetic carrier was selected by magnetic force and coarse particles were removed by a sieve having a mesh size of 74 μm to obtain magnetic carrier A. The results are shown in Table 4.

### Production Examples of Magnetics B to L, S, and T

Magnetic carriers were obtained in the same manner as in Production Example of magnetic carrier A except that materials to be used and use amounts were changed as shown in Table 4 in Production Example of magnetic carrier A. The results are shown in Table 4.

### Production Example of Magnetic Carrier M

The materials described below and a hybridization system (NHS-3 manufactured by Nara Machinery Co., Ltd.) were used to produce magnetic carrier M.

Magnetic carrier core d: 100 parts by mass
Charge control agent 7: 0.2 parts by mass

The hybridization system (NHS-3 manufactured by Nara Machinery Co., Ltd.) will be described referring to FIG. 4. In FIG. 4, the system has a main body casing 151, a stator 158, a stator jacket 177, a recycle pipe 163, a magnetic carrier discharge outlet valve 159 and a raw material inlet valve 164.

In the apparatus, the raw materials supplied through raw material introduction valve 164 momently receive impact given by a plurality of rotor blades 155 arranged in a rotatory rotor 162 rotating at a high speed in a shock chamber 168. Further, the raw materials impinge on the peripheral stator 158 and are scattered in the system while aggregated powder particles are mutually separated and scattered; at the same time, coating is performed. The raw materials are passed a plurality of times through the recycle pipe 163 along with air flow generated by rotation of the rotor blade 155 to perform coating. Coating is further continued while the raw materials repeatedly receive impact from the rotor blade 155 and the stator 158. After a lapse of a predetermined time, when the magnetic carrier outlet valve 159 is opened, magnetic carriers pass through a pipe 359 and are collected by a cyclone 369 communicating with a transport blower 364.

In a primary coating process, a raw material inlet valve 164 was opened to load magnetic carrier core d through the raw material inlet. Then, a charge control agent 7 was loaded and the raw material inlet valve 164 was closed. Thereafter, coating was performed. Coating was performed for 3 minutes under such a coating condition that a rotation circumferential speed of the rotatory rotor 162 is controlled to 50 m/sec so that a load power became constant at 11.0 kW. After completion of the coating process, the magnetic carrier outlet valve 159 was opened to collect particles coated with the charge control agent by the cyclone 369 communicating with the transport blower 364.

Next, as a second coating process, the raw material inlet valve 164 was opened, and the above particle and a particle of the resin composition 4 (1.0 part by mass) were loaded. After the raw material inlet valve 164 was closed, coating was performed. The coating conditions were the same as the conditions in the primary coating process.

After completion of the coating process, the magnetic carrier outlet valve 159 was opened to obtain a magnetic carrier coated with a resin composition by the cyclone 369 communicating with the transport blower 364. The obtained magnetic carrier was selected by magnetic force and coarse particles were removed by a sieve having a mesh size of 74 μm to obtain magnetic carrier M. The results are shown in Table 4.

### Production Example of Magnetic Carrier N

In the Henschel mixer (FM-75 manufactured by Nippon Coke & Engineering Co., Ltd.), charge control agent 1 (10 part by mass) based on the particle of resin composition 1 (100 parts by mass) was added and mixed to obtain a mixture. Note that, mixing was made in the conditions where the outermost circumferential speed of vanes of the stirring portion is 10 m/sec and the mixing time is one minute. The obtained mixture was weighted so as to satisfy 1.2 parts by mass based on the magnetic carrier core c (100.0 parts by mass).

Next, from the raw material inlet 5 of the apparatus shown in FIG. 1, the inner piece 16 for a raw material inlet was taken out and magnetic carrier core c and the above mixture were loaded. Then the inner piece 16 for a raw material inlet was inserted and the inlet was closed airtight. A coating process of the magnetic carrier core c and the above mixture loaded was performed for 10 minutes while the outermost circumferential speed of the stirring member 3 was controlled to be 10 m/sec such that application power reached constant at 3.5 kW.

After completion of the coating process, the inner piece 17 for a magnetic carrier outlet within the magnetic carrier outlet 6 was taken out and the rotatory member 2 was rotated by the driving section 8 to discharge a magnetic carrier from the magnetic carrier outlet 6. The obtained magnetic carrier was selected by magnetic force and coarse particles were removed by a sieve having a mesh size of 74 μm to obtain magnetic carrier N. The results are shown in Table 4.

### Production Example of Magnetic Carrier O

In Production Example of magnetic carrier A, magnetic carrier core a was changed to magnetic carrier core c and charge control agent 1 was changed to charge control agent 4. As the primary coating process, a resin composition was treated. As the second coating process, a charge control agent was treated. In the same manner as in Production Example of magnetic carrier A except the aforementioned conditions, magnetic carrier O was obtained. The results are shown in Table 4.

### Production Example of Magnetic Carrier P

In Production Example of magnetic carrier A, magnetic carrier core a was changed to magnetic carrier core c and the primary coating process was not performed. In the same manner as in Production Example of magnetic carrier A except the aforementioned conditions, magnetic carrier P was obtained. The results are shown in Table 4.

### Production Example of Magnetic Carrier Q

Charge control agent 1 (4.5 parts by mass) was added to a solution of the resin composition 4 (100.0 parts by mass) and mixed. To this, toluene was added such that the solid-substance concentration was 10 mass % to obtain a solution in which the resin composition and the charge control agent were dispersed. Coating was performed by use of a coating apparatus such as a wet-process coating apparatus, i.e., a universal mixing stirrer (manufactured by Fuji Paudal Co., Ltd.). The coating conditions are follows. Magnetic carrier core c (100 parts by mass) was loaded and heated to a temperature of 60° C. Thereafter, a dispersion solution was loaded separately in three portions (at intervals of 10 minutes) such that the solid substance of the dispersion solution was contained in an amount of 1.2 parts by mass based on magnetic carrier core c (100 parts by mass).

In the coating process, coating was performed for 30 minutes while rotating stirring vanes at a rate of 100 turns per minute. Further, the pressure of the mixer was reduced and the atmosphere thereof was replaced with nitrogen by feeding nitrogen at a flow rate 0.1 m³/min. The nitrogen atmosphere was stirred while maintaining the reduced pressure (75 kPa) to remove the solvent until magnetic carriers became dry and smooth. The solvent was completely removed and baking was performed in a cylindrical rotary drying furnace (external heating type rotary kiln, IRK-05 manufactured by Kurimoto, Ltd) at 100° C. for 2 hours. After cooling, the magnetic carrier was selected by magnetic force and coarse particles were removed by a sieve having a mesh size of 74 μm to obtain magnetic carrier Q. The results are shown in Table 4.

### Production Example of Magnetic Carrier R

Toluene (98 parts by mass) was added to 3-aminopropyl trimethoxysilane (2 parts by mass) to prepare a dispersion solution A (solid-substance concentration of 2%). Further, to a solution of resin composition 4 (100.0 parts by mass), charge control agent 1 (4.5 parts by mass) was added and mixed. Subsequently, toluene was added such that solid-substance concentration was 10 mass % to obtain solution B in which the resin composition and the charge control agent were dispersed.

Magnetic carrier core c was loaded to a sun-and-plant motion type mixer (Nauta mixer VN manufactured by Hosokawa Micron Group) and heated to a temperature of 70° C. The dispersion solution A was loaded such that a solid substance was contained in an amount of 0.2 parts by mass based on magnetic carrier core c (100 parts by mass).

In the coating process, a screw-type stirring vane was rotated at a revolution rate of 3.5 turns/minute and at a spinning rate of 100 turns/minute and coating was performed for 30 minutes. Further, nitrogen was supplied to the mixer at a flow rate 0.1 m³/min to replace the atmosphere with nitrogen. The inner pressure of the mixer was reduced to 75 mmHg by nitrogen atmosphere. Subsequently, while the temperature was maintained at 70° C. under reduced pressure (75 mmHg), the above dispersion solution B was loaded so as to satisfy 1.0 part by mass in terms of a solid substance relative to magnetic carrier core c (100.0 parts by mass), coating time was set to 30 minutes. In this manner, the coating process was performed.

After completion of the coating process, the solvent was completely removed to dry the resultant coated material and baking was performed in a cylindrical rotary drying furnace (external heating type rotary kiln, IRK-05 manufactured by Kurimoto, Ltd) at 100° C. for 2 hours. After cooling, the magnetic carrier was selected by magnetic force and coarse particles were removed by a sieve having a mesh size of 74 μm to obtain magnetic carrier R. The results are shown in Table 4.

TABLE 4

| | | | | | | Processing |
|---|---|---|---|---|---|---|
| Magnetic | Magnetic | Primary | Secondary | Coating | Power | time |
| carrier | core | coating process | coating process | appratus | (kW) | (minute) |
| A | a | Charge control | Resin | FIG. 1 | 3.5 + 3.5 | 10 + 10 |
| | | agent 1 | composition 1 | | | |
| B | a | Charge control | Resin | FIG. 1 | 3.5 + 3.5 | 10 + 10 |
| | | agent 2 | composition 1 | | | |
| C | a | Charge control | Resin | FIG. 1 | 3.5 + 3.5 | 10 + 10 |
| | | agent 3 | composition 1 | | | |
| D | a | Charge control | Resin | FIG. 1 | 3.5 + 3.5 | 10 + 10 |
| | | agent 4 | composition 1 | | | |
| E | b | Charge control | Resin | FIG. 1 | 3.5 + 3.5 | 10 + 10 |
| | | agent 4 | composition 1 | | | |
| F | c | Charge control | Resin | FIG. 1 | 3.5 + 3.5 | 10 + 10 |
| | | agent 4 | composition 1 | | | |
| G | d | Charge control | Resin | FIG. 1 | 3.5 + 3.5 | 10 + 10 |
| | | agent 4 | composition 1 | | | |
| H | d | Charge control | Resin | FIG. 1 | 3.5 + 3.5 | 10 + 10 |
| | | agent 4 | composition 2 | | | |
| I | d | Charge control | Resin | FIG. 1 | 3.5 + 3.5 | 10 + 10 |
| | | agent 4 | composition 3 | | | |
| J | d | Charge control | Resin | FIG. 1 | 3.5 + 3.5 | 10 + 10 |
| | | agent 4 | composition 4 | | | |
| K | d | Charge control | Resin | FIG. 1 | 3.5 + 3.5 | 10 + 10 |
| | | agent 5 | composition 4 | | | |
| L | d | Charge control | Resin | FIG. 1 | 3.5 + 3.5 | 10 + 10 |
| | | agent 6 | composition 4 | | | |
| M | d | Charge control | Resin | FIG. 4 | 11.0 + 11.0 | 10 + 10 |
| | | agent 7 | composition 4 | | | |
| N | c | Mixture | | FIG. 1 | 3.5 | 10 |
| | | (Resin composition 1 + | | | | |
| | | Charge control agent 1) | | | | |
| O | c | Resin | Charge control | FIG. 1 | 3.5 + 3.5 | 10 + 10 |
| | | composition 1 | agent 4 | | | |
| P | c | — | Resin | FIG. 1 | 3.5 | 10 |
| | | | composition 1 | | | |
| Q | c | Mixture | | Universal | — | 30 |
| | | (Resin composition 4 + | | mixing stirrer | | |
| | | Charge control agent 1) | | | | |
| R | c | 3-Aminopropyl | Resin | Sun-and-planet | — | 30 + 30 |
| | | trimethoxysilane | composition 4 | mixer | | |
| S | a | Charge control | Resin | FIG. 1 | 3.5 + 3.5 | 10 + 10 |
| | | agent 4 | composition 5 | | | |

| | | | | | |
|---|---|---|---|---|---|
| T | b | Mixture | FIG. 1 | 3.5 | 10 |
| | | (Resin composition 1 + | | | |
| | | Charge control agent 4) | | | |

| | Primary | | Secondary | | | |
|---|---|---|---|---|---|---|
| | coating process | | coating process | Product | | Intensity of |
| Magnetic | Coating amount | Coverage | Coating amount | temperature | D50 | magnetization |
| carrier | (parts by mass) | (area %) | (parts by mass) | (° C.) | (μm) | (Am²/kg) |
| A | Charge control | 94 | Resin | 56 | 35 | 49 |
| | agent 0.3 | | composition 1.5 | | | |
| B | Charge control | 92 | Resin | 57 | 35 | 49 |
| | agent 0.3 | | composition 1.5 | | | |
| C | Charge control | 91 | Resin | 57 | 36 | 48 |
| | agent 0.3 | | composition 1.5 | | | |
| D | Charge control | 91 | Resin | 58 | 35 | 49 |
| | agent 0.3 | | composition 1.5 | | | |
| E | Charge control | 93 | Resin | 56 | 37 | 61 |
| | agent 1.0 | | composition 2.0 | | | |
| F | Charge control | 85 | Resin | 56 | 49 | 53 |
| | agent 0.2 | | composition 1.0 | | | |
| G | Charge control | 82 | Resin | 57 | 37 | 59 |
| | agent 0.2 | | composition 0.8 | | | |
| H | Charge control | 80 | Resin | 57 | 37 | 59 |
| | agent 0.2 | | composition 0.8 | | | |
| I | Charge control | 81 | Resin | 58 | 37 | 59 |
| | agent 0.2 | | composition 0.8 | | | |
| J | Charge control | 80 | Resin | 56 | 37 | 58 |
| | agent 0.2 | | composition 0.8 | | | |
| K | Charge control | 76 | Resin | 56 | 38 | 59 |
| | agent 0.2 | | composition 1.0 | | | |
| L | Charge control | 74 | Resin | 58 | 37 | 59 |
| | agent 0.2 | | composition 1.0 | | | |
| M | Charge control | 65 | Resin | 28 | 37 | 59 |
| | agent 0.2 | | composition 1.0 | | | |
| N | Mixture 1.2 | — | — | 57 | 49 | 53 |
| O | Resin | — | Charge control | 56 | 49 | 53 |
| | composition | | agent 0.3 | | | |
| | 1.5 | | | | | |
| P | — | — | Resin | 58 | 49 | 53 |
| | | | composition 1.5 | | | |
| Q | Mixture 1.2 | — | — | — | 50 | 52 |
| R | 3-Aminopropyl | 87 | Resin | — | 51 | 53 |
| | trimethoxysilane 0.2 | | composition 1.0 | | | |
| S | Charge control | 76 | Resin | 55 | 38 | 57 |
| | agent 0.2 | | composition 0.8 | | | |
| T | Mixture 1.2 | — | — | 57 | 37 | 61 |

### Production Example of Toner α

Polyester resin (peak molecular weight Mp 6500,Tg 65° C.): 100.0 parts by mass

C.I. pigment blue 15:3:10.0 parts by mass
Paraffin wax (melting point 75° C.): 5.0 parts by mass
Aluminum 3,5-di-t-butylsalicylate compound: 0.5 parts by mass

The above materials were mixed by the Henschel mixer (FM-75 manufactured by Nippon Coke & Engineering Co., Ltd.) and then melt-kneaded by a twin screw extruder (PCM-30 manufactured by Ikegai Corporation). The kneaded material was cooled and roughly pulverized by a rough pulverizer (hammer mill manufactured by Hosokawa Micron Group) to obtain a roughly pulverized material.

The obtained roughly pulverized material was further pulverized into fine pieces by a pulverizer (T-250 manufactured by Turbo Kogyo Co., Ltd.) and then classified by a classifier (Elbow jet EJ-LABO manufactured by Nittetsu Mining Co., Ltd.) to obtain toner particles. The obtained toner particles had a weight average particle size (D4) of 6.2 μm.

To the obtained toner particle (100.0 parts by mass), the following materials were externally added by the Henschel mixer (FM-75 manufactured by Nippon Coke & Engineering Co., Ltd.) to produce toner α. The use amounts of the materials and weight average particle sizes of toner particles and toner are shown in Table 5.

Anatase type titanium oxide fine powder: 1.0 part by mass
(BET specific surface area 80 m²/g, treated with isobutyltrimethoxysilane, 12 mass %)
Oil treated silica: 1.5 parts by mass
(treated with silicone oil 15 mass %, BET specific surface
area: 95 m²/g, number average particle size: 16 nm)
Silica by sol-gel process: 3.5 parts by mass
(treated with hexamethyl disilazane: 20 mass %, BET specific surface area: 24 m²/g, number average particle size: 110 nm)

### Production Example of Toner β

Toner β was produced in the same manner as in toner α except that silica produced by a sol-gel process was not added. The use amounts of the materials and weight average particle sizes of toner particles and toner are shown in Table 5.

TABLE 5

| | Toner | Toner | Titanium | Oil treated | Silica by | |
|---|---|---|---|---|---|---|
| | particle D4 | particle | oxide | silica | sol-gel process | Toner D4 |
| | (μm) | (parts by mass) | (parts by mass) | (parts by mass) | (parts by mass) | (μm) |
| Toner α | 6.2 | 100 | 1.0 | 1.5 | 3.5 | 6.3 |
| Toner β | 6.2 | 100 | 1.0 | 1.5 | 0 | 6.2 |

### Example 1

To magnetic carrier A (92 parts by mass), toner α (8 parts by mass) was added. The mixture was shaken by a V-type mixer for 10 minutes to prepare a two-component developer. The following evaluations were performed by use of the two-component developer. The results are shown in Table 6.

As an image forming apparatus, a digital commercial printer, image PRESS C1 (manufactured by Cannon Inc.) plus modified machine was used. The above developer was placed in a developing unit at the position of cyan site and an image was formed and evaluated. The image forming apparatus was modified as follows. The circumferential speed of a developing sleeve was set to 1.5 times as high as that of a photosensitive drum and further the discharging outlet of a supplemental developer was closed to allow only toner to resupply. To the developing sleeve, an alternate current, i.e., square wave having a frequency of 2.0 kHz and Vpp of 1.3 kV and direct current V_{DC} were applied.

Electrification potential (V_{D}) was controlled so as to set a contrast potential (V) to 300V and a fogging removal voltage (Vback) to 150V. Under the conditions, initial image formation and long-term image formation were evaluated.

<Evaluation Method and Criteria>

[Developability]

An electrostatic latent image of a black solid image was formed on a photosensitive drum by electrification and light exposure, and the latent image was developed by use of a two-component developer. Thereafter, rotation of the photosensitive drum was stopped before the toner layer formed on the photosensitive drum was transferred to an intermediate transfer member and a charge amount Q/S of toner developed on the photosensitive drum per unit area was measured. Based on the measurement value, developability was evaluated. Note that, the Q/S value can be obtained by multiplying an absolute value of toner charge amount Q/M per unit mass developed on a photosensitive drum by the amount (load) of toner developed M/S per unit area.

Usually, toner having a large charge amount has a large reflection force with a magnetic carrier and is unlikely to be developed (rarely scattered from the magnetic carrier surface). Accordingly, charge amount and developing amount have an inverse relationship. Therefore, as the product obtained by multiplication of the charge amount by the toner load increases more and more, the developability can be evaluated to increase.

Developability was evaluated based on the following evaluation criteria.

A: Q/S is 16.0 nC/cm² or more.
B: Q/S is 15.0 nC/cm² or more and less than 16.0 nC/cm².
C: Q/S is 14.0 nC/cm² or more and less than 15.0 nC/cm².
D: Q/S is less than 14.0 nC/cm².

[Fogging]

The average reflectivity of paper, Dr (%), was measured by a reflectometer (“REFLECTOMETER MODEL TC-6DS” manufactured by Tokyo Denshoku Co., Ltd.). Next, a while solid image was printed on a single A4 sheet (Vback was set to 150V) and the white solid image reflectivity Ds (%) was measured. The fogging rate (%) thereof was calculated by use of the following formula. The obtained fogging was evaluated in accordance with the following evaluation criteria.

(Fogging Evaluation Criteria)

Fogging rate (%)=Dr (%)−Ds (%)

A: Fogging rate is less than 0.5%.
B: Fogging rate is 0.5 or more and less than 1.0%.
C: Fogging rate is 1.0 or more and less than 2.0%.
D: Fogging rate is 2.0% or more.

[Retention of Toner Charge Amount Q/M (mC/kg) per Unit Mass in 100,000 Image Formation Test]

An image formation test of forming 100,000 images having a printing ratio of 5% was performed under a high-temperature and high-humidity (30° C., 80% RH) environment. After the image formation test, a developer was sampled to check the concentration of toner in the developer. In the case where a toner concentration of a developer changes from the initial concentration by 8%, toner is resupplied to a developing unit or image was formed while supplement of toner is stopped thereby consuming toner. In this way, the toner concentration after the image formation test was controlled to be 8%.

In the beginning of the image formation test, an image having a toner load of 0.5 g/cm² was formed. At the time toner is loaded on a photosensitive member, an apparatus was stopped. The photosensitive member was taken out from the apparatus and the toner charge amount Q/M (mC/kg) per unit mass on the photosensitive member was measured in accordance with the aforementioned measurement method.

Subsequently, after the image formation test was performed, the toner charge amount per unit mass Q/M (mC/kg) on the photosensitive member after formation of 100,000 images was measured. Based on the initial Q/M, which was regarded as 100%, a retention rate of toner Q/M on the photosensitive member after formation test of 100,000 images was calculated and determined in accordance with the following criteria.

A: The retention rate is 90% or more.
B: The retention rate is 80% or more and less than 90%.
C: The retention rate is 70% or more and less than 80%.
D: The retention rate is 60% or more and less than 70%.
E: The retention rate is less than 60%.

[Retention Property of Q/M(mC/kg) after Leaving in Environment]

Under a normal-temperature and normal-humidity (23° C., 50% RH) environment, an image formation test of forming 100,000 images having a printing ratio of 5% was performed. Then, in the same manner as above, the toner charge amount Q/M per unit mass on a photosensitive member after formation of 100,000 images was measured. Thereafter, the developing unit was taken out of the apparatus and left alone under a high-temperature and high-humidity (40° C., 90% RH) environment for 72 hours, and again installed in the apparatus. Image of a 5% printing ratio was formed and the toner charge amount Q/M per unit mass on a photosensitive member after left in the environment for 72 hours was measured.

The Q/M on a photosensitive member at the time of image evaluation after 100,000-image formation test was regarded as 100%, a Q/M retention rate on a photosensitive member after left in environment for 72 hours was calculated and determined based on the following criteria.

A: The retention rate is 90% or more.
B: The retention rate is 80% or more and less than 90%.
C: The retention rate is 70% or more and less than 80%.
D: The retention rate is 60% or more and less than 70%.
E: The retention rate is less than 60%.

### Examples 2 to 14, Comparative Examples 1 to 6

Evaluation was performed in the same manner as in Example 1 except that toner, magnetic carrier, toner concentration of Example 1 were changed to those shown in Table 6. The evaluation results are shown in Table 6.

TABLE 6

| | | | | | | Evaluation-3: | Evaluation-4: |
|---|---|---|---|---|---|---|---|
| | | | | | | Q/M retention | Q/M retention |
| | | | Toner | | | rate after | rate after |
| | | Magnetic | concentration | Evaluation-1: | Evaluation-2: | 100,000 image | leaving in |
| | Toner | carrier | (parts by mass) | Developability | Fogging | formation test | environment |
| Example 1 | α | A | 8 | A | A | A | A |
| | | | | 17.2 | 0.2 | 97 | 94 |
| Example 2 | α | B | 8 | A | A | A | B |
| | | | | 16.8 | 0.3 | 94 | 88 |
| Example 3 | α | C | 8 | A | A | A | B |
| | | | | 16.0 | 0.4 | 93 | 86 |
| Example 4 | α | D | 8 | A | A | A | B |
| | | | | 16.0 | 0.5 | 92 | 85 |
| Example 5 | α | E | 8 | B | B | B | B |
| | | | | 15.5 | 0.5 | 84 | 84 |
| Example 6 | α | F | 7 | B | B | B | B |
| | | | | 15.8 | 0.7 | 87 | 88 |
| Example 7 | α | G | 7 | B | B | B | C |
| | | | | 15.2 | 0.8 | 83 | 79 |
| Example 8 | α | H | 7 | B | B | C | C |
| | | | | 15.1 | 0.9 | 79 | 75 |
| Example 9 | α | I | 7 | B | B | B | C |
| | | | | 15.3 | 0.8 | 82 | 77 |
| Example 10 | α | J | 7 | B | C | C | C |
| | | | | 15.0 | 1.5 | 73 | 74 |
| Example 11 | α | K | 7 | C | C | C | C |
| | | | | 14.8 | 1.2 | 78 | 77 |
| Example 12 | α | L | 7 | C | C | C | C |
| | | | | 14.8 | 1.2 | 77 | 76 |
| Example 13 | β | M | 7 | C | C | C | C |
| | | | | 14.0 | 1.8 | 74 | 72 |
| Example 14 | α | S | 7 | B | B | B | C |
| | | | | 15.1 | 0.9 | 80 | 72 |
| Comparative | α | N | 7 | C | C | C | D |
| Example 1 | | | | 14.8 | 1.4 | 74 | 68 |
| Comparative | α | O | 7 | C | C | D | D |
| Example 2 | | | | 14.8 | 1.6 | 68 | 66 |
| Comparative | α | P | 7 | C | C | D | D |
| Example 3 | | | | 14.0 | 1.7 | 65 | 62 |
| Comparative | α | Q | 7 | D | D | E | E |
| Example 4 | | | | 13.8 | 2.3 | 58 | 56 |
| Comparative | α | R | 7 | D | D | E | E |
| Example 5 | | | | 13.5 | 2.4 | 55 | 54 |
| Comparative | α | T | 7 | C | C | C | D |
| Example 6 | | | | 14.8 | 1.5 | 72 | 68 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-198639, filed Sep. 6, 2010, which is hereby incorporated by reference herein in its entirety.

What is claimed is:

1. A magnetic carrier comprising magnetic carrier particles, each of which comprises a magnetic carrier core, a charge control agent and a resin composition, wherein
the surface of the magnetic carrier core is coated with the charge control agent, and wherein a resin coat layer containing the resin composition is present on the surface of a coat of the charge control agent.

2. The magnetic carrier according to claim 1, wherein the surface of the magnetic carrier core is coated with the charge control agent in a coverage rate of 70 area % or more.

3. The magnetic carrier according to claim 1, wherein the charge control agent contains a quaternary ammonium salt.

4. The magnetic carrier according to claim 1, wherein the resin composition contains a tetrahydrofuran (THF)-soluble matter having a weight average molecular weight (Mw) of from 100,000 or more to 1,000,000 or less.

5. The magnetic carrier according to claim 1, wherein the magnetic carrier core contains a ferrite component and a SiO₂ component.

6. The magnetic carrier according to claim 1, wherein the magnetic carrier is obtained by dry-process coating the magnetic carrier core with the charge control agent, and further dry-process coating the thus coated magnetic carrier core with the resin composition.

7. The magnetic carrier according to claim 6, wherein the dry-process coating is performed by using a dry-process coating apparatus, the dry-process coating apparatus having a cylindrical rotatory member having a plurality of stirring members and a driving section configured to rotate the rotatory member; the plurality of stirring members being arranged in rows in the direction along the rotation shaft of the rotatory member; and the rotatory member being rotated to perform the coating.

8. A two-component developer comprising a toner and a magnetic carrier, wherein the magnetic carrier is the magnetic carrier according to claim 1.

9. A process for producing a magnetic carrier comprising the steps of:
dry-process coating a magnetic carrier core with a charge control agent; and further dry-process coating the thus coated magnetic carrier core with a resin composition.

10. The process for producing the magnetic carrier according to claim 9,
wherein the dry-process coating is performed by using a dry-process coating apparatus, the dry-process coating apparatus having a cylindrical rotatory member having a plurality of stirring members and a driving section configured to rotate the rotatory member; the plurality of stirring members being arranged in rows in the direction along the rotation shaft of the rotatory member; and the rotatory member being rotated to perform the coating.
